(19) United States
(12) Patent Application Publication
(10) Pub. No.: US 2026/0018364 A1
(43) Pub. Date: Jan. 15, 2026

(54) X-RAY TUBE WITH FIELD EFFECT EMITTER

(71) Applicant: Siemens Healthineers AG, Forchheim (DE)

(72) Inventors: Christoph JUD, Nuernberg (DE); Peter GEITHNER, Erlangen (DE); Joerg FREUDENBERGER, Kalchreuth (DE); Anja FRITZLER, Erlangen (DE); Michael WIMMER, Weisendorf (DE)

(73) Assignee: Siemens Healthineers AG, Forchheim (DE)

(21) Appl. No.: 19/264,921

(22) Filed: Jul. 10, 2025

(30) Foreign Application Priority Data
Jul. 11, 2024 (DE) 10 2024 206 550.1

(51) Int. Cl. H01J 35/06; H01J 35/10

(52) U.S. Cl. CPC H01J 35/065; H01J 35/10

(57) ABSTRACT

An X-ray tube has a tube body, which encloses a tube volume in a gas-tight manner. An emitter electrode, a gate electrode and an anode are arranged within the tube volume. The emitter electrode is embodied as an unheated electrode which has a plurality of emitter needles arranged on a substrate in a region facing the gate electrode. The gate electrode is divided into a main region and a number of additional regions by insulating structures introduced into the gate electrode. An emission voltage is applied to the main region relative to the emitter electrode. The additional regions are electrically conductively connected to the main region only by way of connecting bridges. At least one cutout of the gate electrode is arranged in the additional regions in each case.

### CROSS-REFERENCE TO RELATED APPLICATION(S)

The present application claims priority under 35 U.S.C. § 119 to German Patent Application No. 10 2024 206 550.1, filed Jul. 11, 2024, the entire contents of which are incorporated herein by reference.

### RELATED ART

An X-ray tube is generally known. WO 2013/136 299 A1 and EP 3 748 667 A1 can be cited purely by way of example.

It is known to embody the emitter electrode of an X-ray tube as a field effect emitter. It is possible to achieve a high current density with an embodiment of this type. Reference can be made in this regard purely by way of example to the scientific paper “Silicon Field Emitter Arrays With Current Densities Exceeding 100 A/cm2 at Gate Voltages Below 75 V” by Guerrera et al., published in IEEE ELECTRON DEVICE LETTERS, VOL. 37, NO. 1, January 2016.

When a field effective emitter is used as an emitter electrode, an excessive gate current may result due to different reasons. By way of example, on account of errors in the manufacturing process or on account of mechanical damage individual emitter needles may form an electrical contact with the gate electrode so that a short circuit develops. Impurities or excessive currents through individual emitter needles may also bring about a short circuit of this type. A further possible cause are flashovers between the anode and the emitter electrode.

A flashover may have various consequences. One possible consequence is that the gate electrode evaporates in a subregion. In this case, gate electrodes are no longer available for the emitter needles disposed below the evaporated region, via which gate electrodes the electrical field is formed which excites the electrons to leave the emitter needles. Nevertheless, the remaining region of the emitter electrode is still functional. A further possible consequence is that the gate electrode in a subregion does not evaporate but instead melts, and in this way in this subregion seals off the cutouts and then solidifies again. In this case, the gate electrode is still available for the emitter needles below the melted and resolidified subregion, the electrons leaving the emitter needles in this subregion can however no longer reach the anode but are instead received by the gate electrode. This results in a current through the gate electrode. As a result, the gate electrode can either only be heated, which is harmless. Alternatively, the gate electrode can melt again and subsequently solidify again. In turn, the gate electrode can alternatively evaporate.

One further possible consequence of a flashover is that the gate electrode melts and in the process forms an electrically conductive connection to one or more of the emitter needles. In this case, a short circuit occurs between the gate electrode and emitter electrode. A short circuit of this type may have an impact on the entire field effect emitter array. After a short circuit of this type, the array can only function in a restricted manner, if at all. The X-ray tube is no longer fully functional.

Most of the gate electrode would theoretically also be functional. With a uniform control of the gate electrode and the emitter electrode, in other words without dividing the gate electrode and/or the emitter electrode into subregions which can be operated independently of one another, this is not possible, however. The problem is explained by way of example by R. F. Asadi, T. Zheng, J. Da Silva, G. Rughoobur, A. I. Akinwande and B. Gnade in the conference contribution “Failure Mode of Si Field Emission Arrays based on Emission Pattern Analysis”, 2021 34th International Vacuum Nanoelectronics Conference (IVNC), Lyon, France, 2021, pp. 1-2, doi: 10.1109/IVNC52431.2021.9600740.

It is already known to subdivide the gate electrode and/or the emitter electrode into subregions which can be operated independently of one another, see already cited WO 2013/136 299 A1 and likewise already cited EP 3 748 667 A1. This procedure results in only one subregion of the gate electrode and/or one subregion of the emitter electrode failing in the event of a short circuit.

### SUMMARY

This solution is nevertheless disadvantageous in that the deactivation of the malfunctioning subregion must take place actively. A corresponding sensor system with a downstream logic is therefore necessary in order to identify defective subregions. Furthermore, control of the subregions which is based hereupon is necessary. The complexity of the design therefore increases to a significant degree. Increased costs are also associated herewith.

One or more example embodiments creates a simple and cost-effective possibility, via which only subregions fail in the event of a short circuit between the gate electrode and the emitter electrode.

The is achieved by an X-ray tube having the features of claim 1. Advantageous embodiments of the X-ray tube form the subject matter of the dependent claims 2 to 4.

### BRIEF DESCRIPTION OF THE DRAWINGS

Properties, features and advantages of example embodiments and the manner in which these are achieved will become clearer and more intelligible in conjunction with the following description of the exemplary embodiments, which are explained in more detail in conjunction with the drawings. The drawings show in a schematic representation:

FIG. 1 illustrates an X-ray tube according to one or more example embodiments;

FIG. 2 illustrates a small section of an electrode arrangement from the side according to one or more example embodiments,

FIG. 3 illustrates a larger section of the electrode arrangement in FIG. 2 from above according to one or more example embodiments, and

FIG. 4 illustrates a block diagram.

### DETAILED DESCRIPTION

In accordance with one or more example embodiments, an X-ray tube of the type cited in the introduction is configured in that, the gate electrode is subdivided into a main region and a number of additional regions by insulating structures introduced into the gate electrode,
the emission voltage relative to the emitter electrode is applied to the main region,
the additional regions are electrically conductively connected to the main region only by way of connecting bridges and
at least one cutout is arranged in the additional regions in each case.

Via this embodiment, it is achieved that in the case of a short circuit in one of the additional regions, the connecting bridge, in principle like a fusible cutout, “fuses” and as a result electrically separates the corresponding additional region from the main region. Therefore, the corresponding additional region subsequently no longer connects to the potential which is applied to the main region. Instead, on account of the short circuit the corresponding additional region is connected to the potential which is applied to the emitter electrode. On account of the electrical separation of the additional region from the main region and thus also from the other additional regions, this nevertheless only has an impact on the corresponding additional region. The main region and the other additional regions may by contrast also be connected to the potential which is applied to the main region. The remaining part of the gate electrode can therefore also be used.

The number of cutouts which are disposed in a respective subregion of the gate electrode may be determined if required. Typically, cutouts are disposed in a respective subregion of the gate electrode n1×m1, wherein n1 and m1 may be any natural numbers. Typically n1 and m1 are approximately the same size, however.

Similarly, the number of emitter needles which are disposed below a respective cutout may also be determined, if required. Emitter needles are typically disposed below a respective cutout in the gate electrode n2×m2, wherein n2 and m2 may be any natural numbers. n2 and m2 are typically almost the same size, however.

On account of the inventive embodiment, it is not necessary to divide the emitter electrode into different subregions, which can be controlled independently of one another. This is also possible however. In this case, the emitter needles form a number of individually controllable groups. With a group formation, it is also possible to match the groups to the subregions. This is also not necessary, however.

The field effect emitters can consist of any suitable material. The emitter needles preferably consist of silicon (Si), alternatively of molybdenum (Mo). Via this embodiment, high current densities of up to 100 A/cm2 are possible. The use of silicon offers the additional advantage that the material as such functions intrinsically and also as a current limitation.

The emitter needles preferably form a regular, in particular periodic grid.

Independent of the grammatical term usage, individuals with male, female or other gender identities are included within the term.

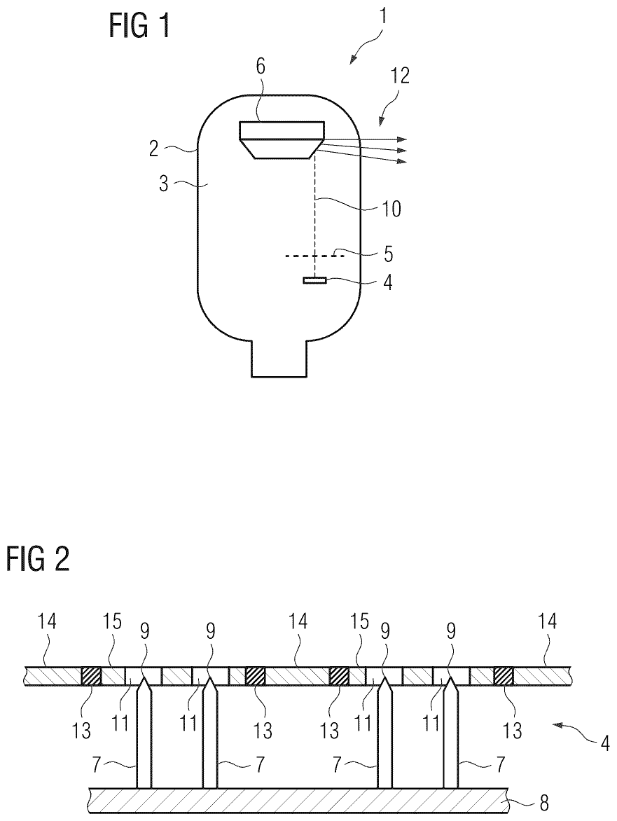

According to FIG. 1, an X-ray tube 1 has a tube body 2. The tube body 2 can consist of glass, for instance. The tube body 2 encloses a tube volume 3 in a gas tight manner. The tube volume 3 is evacuated. An emitter electrode 4, a gate electrode 5 and an anode 6 are (inter alia) arranged within the tube volume 3. The gate electrode 5 is arranged between the emitter electrode 4 and the anode 6, namely in the immediate vicinity of the emitter electrode 4. The gate electrode 5 is embodied in a mesh-type manner. The anode 6 can be embodied as a typical rotating anode. The electrodes 4 to 6 are connected to an electronic system arranged outside of the tube volume 3 by way of electrical lines (not shown).

According to FIGS. 2 and 3, the emitter electrode 4 is embodied as an unheated electrode, in other words what is known as a cold emitter. It has a plurality of emitter needles 7 in a region facing the gate electrode 5. The emitter needles 7 are for their part arranged on a substrate 8. The emitter needles 7 preferably consist of silicon (Si) or molybdenum (Mo). They form, as is readily recognizable, a regular, in particular periodic grid.

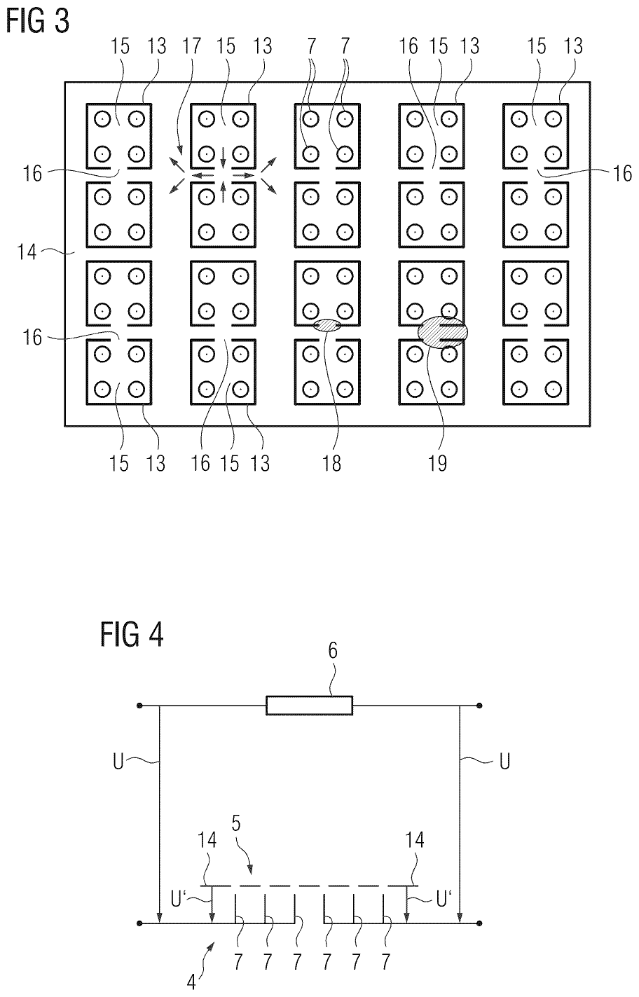

The arrangement of the emitter electrode 4 and the gate electrode 5 are matched to one another so that electrons 10 (see FIG. 1) leave the emitter needles 7 by applying an emission voltage U′ (see FIG. 4) between the emitter electrode 4 and the gate electrode 5 on account of the electrical field formed as a result at tips 9 of the emitter needles 7. If the emission voltage U′ between the emitter needles 7 of the emitter electrode 4 and the gate electrode 5 is sufficiently high, the emitter needles 7 at their tips 9 therefore emit free electrons into the region between the emitter needles 7 and the gate electrode 5. The emission voltage U′ is lower than 1 kV, generally even lower than 100 V, for instance approx. 50 V.

On account of the mesh-type embodiment of the gate electrode 5, the gate electrode 5 according to FIGS. 2 and 3 has cutouts 11. A part of the emitter needles 7 is arranged below the cutouts 11. The electrons 10 which leave the tips 9 of the emitter needles 7 arranged below the respective cutout 11 are therefore firstly accelerated by the emission voltage U′ and leave the immediate vicinity of the tip 9 of the respective emitter needle 7. The electrons 10 are also sucked out of the close-up range around the emitter needles 7 on account of a high voltage U (see FIG. 4) applied between the emitter electrode 4 and the anode 6 and are accelerated through the cutouts 11 onto the anode 6. The high voltage U is therefore in the double-digit, sometimes also triple-digit kilovolt range. The electrons 10 striking the anode 6 generate X-ray radiation 12 there. The anode 6 can be embodied as a rotary anode, for instance.

According to FIG. 3—sometimes also apparent from FIG. 2, insulating structures 13 are introduced into the gate electrode 5. Via the insulating structures 13, the gate electrode 5 is divided into a main region 14 and a number of additional regions 15. Via the insulating structures 13 the additional regions 15 are electrically conductively connected to the main region 14 by way of connecting bridges 16. At least one of the cutouts 11 is also arranged in the additional regions 15 in each case. In FIG. 3, only a very few of the insulating structures 13, the additional regions 15 and the connecting bridges 16 are provided with their reference characters. The same applies to the emitter needles 7 and their tips 9.

According to FIG. 4 the emission voltage U′ relative to the emitter electrode 4 is applied to the main region 14.

As a rule one part of the electrons 10 does not pass through the cutouts 11 and therefore also does not strike the anode 6. Instead, this part of the electrons 10 strikes the gate electrode 5. This is unavoidable with a typical embodiment and can be tolerated in certain limits. It is essential that the gate electrode 5 is not heated excessively by the electrons 10 and the current flow produced as a result. This applies equally to the prior art and one or more example embodiments. If the electrons 10 strike the gate electrode 5, they produce a current there. By way of example, a possible current flow is indicated by arrows 17 in FIG. 3. While the current flow does not exceed a limit value over a specific connecting bridge 16, this has no continuous impact. If, however, the current flow exceeds the limit value, for instance on account of a short circuit of one of the emitter needles 7 with the gate electrode 5, the gate electrode 5 melts or evaporates in the region of the connecting bridge 16, which supports the said current flow. As a result, the corresponding connecting bridge 16 is interrupted. FIG. 3 shows by way of example a small region 18 in which an individual connecting bridge 16 is evaporated, and a larger region 19, in which two adjacent connecting bridges 16 are evaporated.

As a result, via the inventive embodiment it is possible if an excessively high current flows over a respective connecting bridge 16 for the additional region 15 surrounded by the respective insulating structure 13 to be electrically separated from the main region 14. This additional region 15 can no longer be applied with the potential which is supplied to the main region 14 after the corresponding connecting bridge 16 has been interrupted. The main region 14 and the unaffected additional regions 15 can by contrast also operate correctly.

It is possible for the emitter needles 7 to always be controlled uniformly. According to the representation in FIG. 4, the emitter needles 7 however preferably form a number of individually controllable groups. Each group of emitter needles 7 can be supplied with a separate potential in each case. The number of groups of emitter needles 7 shown in FIG. 4 is purely exemplary. Generally more than just one of the two groups of emitter needles 7 shown is present. Similarly, the number of emitter needles 7 shown in FIG. 4 per group is purely exemplary. The groups generally comprise significantly more emitter needles 7.

One or more example embodiments has a number of advantages. In particular, an x-ray tube is produced, in which on account of the structure of the gate electrode 5, additional regions 15 of the gate electrode 5, in which a short circuit exists with the emitter electrode 5, are automatically separated from the main region 14 and the other additional regions 15 of the gate electrode 5. A so-called pixelation of the emitter electrode 4 is not required, even when this is also possible.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially descriptors relative herein interpreted s used accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the invention has been illustrated and described in detail by the preferred exemplary embodiments, the invention is not restricted by the disclosed examples and other variations can be derived from the person skilled in the art without departing from the protective scope of the invention.

We claim:

1. An X-ray tube, comprising:
a tube body enclosing a tube volume in a gas tight manner;
an emitter electrode within the tube volume, the emitter electrode being an unheated electrode which having a plurality of emitter needles arranged on a substrate in a region facing a gate electrode;
the gate electrode within the tube volume, the emitter electrode and the gate electrode are matched to one another such that applying an emission voltage between the emitter electrode and the gate electrode based on an electrical field formed as a result at tips of the emitter needles causes electrons to leave the emitter needles; and
an anode within the tube volume, wherein the gate electrode includes,
cutouts, below which one part of the emitter needles is arranged for each cutout, such that the electrons which leave the tips of the emitter needles below the respective cutout are to be accelerated through the cutouts onto the anode based on a high voltage applied between the emitter electrode and the anode,
wherein the gate electrode is divided into a main region and a number of additional regions by insulating structures in the gate electrode,
the emission voltage relative to the emitter electrode is applied to the main region,
the additional regions are electrically conductively connected to the main region only by connecting bridges, and
at least one cutout is in each of the additional regions.

2. The X-ray tube of claim 1, wherein the emitter needles form a number of individually controllable groups.

3. The X-ray tube of claim 1, wherein the emitter needles consist of silicon or molybdenum.

4. The X-ray tube of claim 1, wherein the emitter needles form a regular grid.

5. The X-ray tube of claim 4, wherein the regular grid is periodic.

6. The X-ray tube of claim 2, wherein the emitter needles consist of silicon or molybdenum.

7. The X-ray tube of claim 2, wherein the emitter needles form a regular grid.

8. The X-ray tube of claim 7, wherein the regular grid is periodic.

9. The X-ray tube of claim 3, wherein the emitter needles form a regular grid.

10. The X-ray tube of claim 9, wherein the regular grid is periodic.
